(19) United States
(12) Patent Application Publication
(10) Pub. No.: US 2007/0129838 A1
(43) Pub. Date: Jun. 7, 2007

(54) Method and system for generating foundry skew models using principal components analysis

(76) Inventor: Peter Bendix, Redwood City, CA (US)

Correspondence Address: BRIAN M BERLINER, ESQ;O'MELVENY & MYERS, LLP, 400 SOUTH HOPE STREET, LOS ANGELES, CA, 90071-2899, US

(21) Appl. No.: 11/294,867

(22) Filed: Dec. 5, 2005

(51) Int. Cl. G06F 19/00

(52) U.S. Cl. 700/121; 700/109

(57) ABSTRACT

Foundry skew models represent the variation in various manufacturing parameters for a given semiconductor manufacturing process. Typically, foundry skew models are generated by the foundries by taking measurements on large numbers of wafers. In many cases skew models are not available for a new process or are suspect because they are based on limited actual measurements. Methods and systems are provided for using principal components analysis to generate foundry skew models for new semiconductor manufacturing processes that have limited or no actual measurements available. In one embodiment, the method generally comprises: selecting an existing foundry skew model for an existing semiconductor manufacturing process; selecting typical model parameters for the existing foundry skew model; and performing principal component analysis on the typical model parameters.

### BACKGROUND OF THE INVENTION

1. Field of the Invention

The present invention relates to the field of semiconductor manufacturing, and more specifically to the generation of skew models to characterize manufacturing process variations.

2. Description of Related Art

Foundry skew models represent the variation in various manufacturing parameters for a given semiconductor manufacturing process. These skew models are typically used by circuit designers to guarantee that circuits not yet manufactured will perform acceptably once built. The skew models tell the designers how much a given parameter will vary, allowing them to simulate circuit designs under a variety of conditions and determine the range of behavior that will occur on an actual device.

Typically, foundry skew models are generated by the foundries by taking measurements on large numbers of wafers and then analyzing this data. One method of generating physically meaningful process spreads for foundry model parameters on mature processes has been the use of principal components analysis. This approach generally involves: (a) taking a large number of measurements across many different die and many different wafers for a particular process technology; (b) extracting a separate set of model parameters for each set of measured data; (c) using the sets of model parameters, calculate the principal components using principal components analysis; (d) adding a selected number of standard deviations to each principal component (e.g., one sigma, two sigma, etc.), based on the variances (i.e., sigmas) of the principal components; and (e) transforming the principal component sigmas back onto the original model parameter set to get the sigmas of the model parameters. The technique of principal components analysis is described in detail in Chapter 2 of Multivariate Analysis: Methods and Applications, by William R. Dillon and Matthew Goldstein, published by John Wiley and Sons, 1984.

The process described above yields a Monte Carlo skew model for the manufacturing process for a golden die most representative of the process center. The sigmas of the model parameters represent the probability of an expected variation around the typical value for each model parameter. In the approach described above, one extracts data for a single foundry process (e.g., 0.13 u, 90 nm, 65 nm, etc.), such that the resulting Monte Carlo skew model is a process specific skew model.

One disadvantage of the approach described above is that it requires a mature process from which data can be obtained. A large number of measurements under different conditions are needed for the resulting sigmas to be accurate. However, Monte Carlo skew models are typically needed early in the design phase, long before the process is stable. Another disadvantage of the approach described above is that gathering large amounts of data and extracting large numbers of model parameter sets is very tedious and time consuming. Finally, if the model parameter sets are extracted manually, it is quite likely that data entry errors will cause statistical noise to be introduced by the extraction procedure that has nothing to do with actual process skew. Accordingly, what is needed is an automated method of generating skew models for processes in advance of the time it takes for the new process to stabilize when there are limited or no actual measurements available for the new process.

### SUMMARY OF THE INVENTION

The present invention addresses the problems described above by generating accurate skew models for a new process by using typical model parameters for a previous process and an adjustment to the new process. Model parameter values from a mature process are used to generate parameter correlation and sigma values. These values can then be used in conjunction with typical values for the new process to generate a complete statistical skew model.

In accordance with one aspect of the embodiments described herein, there is provided a method for generating a new foundry skew model for a new semiconductor manufacturing process, comprising: selecting an existing foundry skew model for an existing semiconductor manufacturing process; selecting typical model parameters for the existing foundry skew model; and performing principal component analysis on the typical model parameters to generate linear equations that comprise principal components, each principal component accounting for different degrees of variance in the typical model parameters. The method further comprises extracting a subset of the principal components that account for the majority of the variance in the typical model parameters, the extracted principal components each having associated principal component variances. The method further comprises: transforming the principal component variances into typical model variances for the typical model parameters; and generating the new foundry skew model by utilizing the typical model variances.

In accordance with another aspect of the embodiments described herein, there is provided a computer program product contained on a storage media and having instructions executable by a processor. In one embodiment, the instructions comprise: selecting an existing foundry skew model for an existing semiconductor manufacturing process; selecting typical model parameters for the existing foundry skew model; and performing principal component analysis on the typical model parameters to generate linear equations that comprise principal components, each principal component accounting for different degrees of variance in the typical model parameters. The instructions further comprise: extracting a subset of the principal components that account for the majority of the variance in the typical model parameters, the extracted principal components each having associated principal component variances; transforming the principal component variances into typical model variances for the typical model parameters; and generating the new foundry skew model by utilizing the typical model variances.

In accordance with yet another aspect of the embodiments described herein, there is provided a system for generating a new foundry skew model for a new semiconductor manufacturing process. The system comprises: a memory unit that stores data files, the data files comprising typical model parameters for an existing semiconductor manufacturing process; and a processor that is in communication with the memory unit. The processor is typically programmed to: retrieve the typical model parameters for the existing foundry skew model; perform principal component analysis on the typical model parameters to generate linear equations that comprise principal components, each principal component accounting for different degrees of variance in the typical model parameters; and extract a subset of the principal components that account for the majority of the variance in the typical model parameters, the extracted principal components each having associated principal component variances. The processor is further programmed to: transform the principal component variances into typical model variances for the typical model parameters; and generate the new foundry skew model by utilizing the typical model variances.

A more complete understanding of the disclosed method and system for generating foundry skew models will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 provides an embodiment of a transistor manufactured according to a process characterized by variations in its manufacturing parameters.

FIG. 2 is a block diagram of an embodiment of a system for generating a foundry skew model.

FIG. 3 provides a flow diagram for a method of using principal component analysis to generate a foundry skew model for a new manufacturing process.

FIG. 4 provides a comparison of the modeled skew distribution and the measured skew distribution for a semiconductor manufacturing process.

### DETAILED DESCRIPTION OF THE PREFERRED EMBODIMENT

A goal of the present invention is to create accurate skew models without having to gather large data sets and extracting parameter sets from them. An assumption underlying the basic approach described herein is that the principal components are relatively the same for many technologies, such that the principal components are determined more by the model being used (e.g., BSIM3, EKV, etc.) than by the particular technology. While the specific values of the parameters of a given model can be very different for different technologies, the correlations between the model parameters are relatively model specific. In effect, the present invention provides a model specific skew model rather than a process specific skew model, which is in contrast to the traditional approach described above. Under the traditional approach, the principal components are determined more by the technology rather than the type of model implemented.

An advantage of the skew model approach described herein is that it is possible to use extracted parameter sets from older technologies that are already fully mature and characterized. Extracted parameter sets and data for the older technologies can be used to determine the principal components for the new technology as long as the same type of skew model is implemented. Once the principal components have been determined, they are then applied to the new technology's model parameter set to generate the appropriate Monte Carlo model. This can be done without having to gather large amounts of data for the new technology. Also, often there is little or no data for new technologies and the skew models generated using the approach described herein may actually be more accurate than those constructed using the traditional approach with little data.

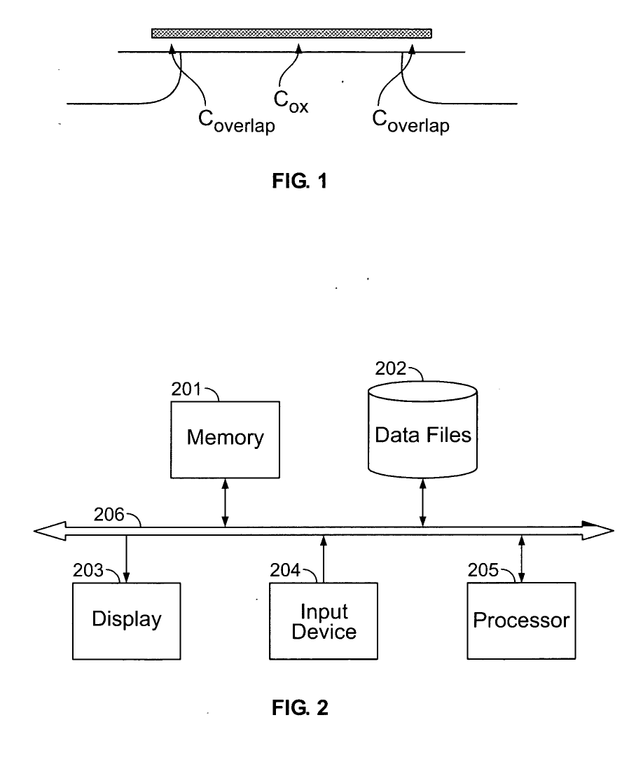

Principal components analysis can be used to understand the correlations between model parameters. Understanding these correlations is necessary because while the statistical variation in the parameters of a model can be characterized individually, it cannot be assumed that the variation in each model parameter is independent. This would result in gross over-skewing in many circumstances, which would result in overly pessimistic projections of device behavior. FIG. 1, which illustrates a MOS transistor, demonstrates this concept. C_{OX} is the gate oxide capacitance per unit area and is inversely proportional to the model parameter T_{OX}, the oxide thickness. C_{OVERLAP} is the gate-source and gate-drain overlap capacitance per channel width and is equal to the model parameters CGS0 and CGD0 respectively. In a typical MOS device, C_{OX} and C_{OVERLAP} are correlated. This means that the model parameter T_{OX} is inversely correlated with CGS0 and CGD0. If T_{OX} goes up, CGS0 and CGD0 should go down. Thus, the simultaneous skewing of T_{OX} upward and the skewing of CGS0 and CGD0 upward does not generally occur. The skew models preferably account for these correlations so that an accurate model of process variation can be determined.

In determining correlations between model parameters, each possible correlation could be individually measured. Given n variables, there are (n * (n−1))/2 pairs of variables. For a large number of variables, there would be too many pairs to individually analyze them. For example, there are hundreds of parameters in the BSIM3 model, many of which are correlated with other parameters. Developing statistical models for accounting for process variation based on samples of these parameters is very difficult because of all the correlations. To address this difficulty, it is desirable to have a data reduction technique that maintains most of the original information while reducing the number of variables and accounts for most of the variance in the data. Principal components analysis can be used for this purpose.

Principal components analysis is a technique that transforms the original set of variables into a smaller set of linear combinations of the original variables that account for most of the variance. The result of principal components analysis is a set of linear combinations (PC1, PC2, etc.) ordered according to the degree of variance in the data accounted for. That is, PC1 accounts for the largest variance in the data, PC2 accounts for the next largest variance, etc. Thus, by taking the top few principal components and discarding the remaining ones, most of the variance in the original parameters is accounted for. Additionally, the principal components are constructed so that they are totally uncorrelated with each other (i.e., they are orthogonal to each other). Having a relatively small number of parameters, all of which are uncorrelated with each other, it is relatively straightforward to develop physically meaningful Monte Carlo skew models. These statistical models can then be used to accurately capture the best-to-worst case process conditions.

The traditional approach to applying principal components analysis to foundry skew models is process specific, and generally involves transforming model parameters to principal components, creating skew models for the principal components, and translating these skew models back into the original model parameters. In one approach, the traditional method involves:

1. Calculating the means and variances of model parameters:
meanₖ=Σᵢ(Pₖ)ᵢ
varₖ²=(1/(n−1))Σ_{i,j} (Pₖ)ᵢ(Pₖ)ⱼ

2. Standardizing the data by subtracting the mean and dividing by the variance:
pᵢ=(pᵢ −meanᵢ)/varᵢ

3. Calculating the correlation coefficient matrix:
cor_{i,j}=Σₖ(pᵢ)ₖ(pⱼ)ₖ

4. Calculating the eigenvectors and eigenvalues of the correlation coefficient matrix.

The eigenvectors of the correlation matrix are the principal components. These are linear combinations of the original variables, guaranteed by construction to be orthogonal (i.e., uncorrelated). The eigenvalues of the correlation matrix are the variances, and the number of the eigenvalues equals the number of original variables. Typically if one keeps the first five to ten principal components and discards the remaining ones, this is sufficient to account for most of the variation in the original variables. A comparison of the eigenvalue for a principal component to the largest eigenvalue can be made to determine how many principal components should be retained.

For a square matrix, M, the eigenvectors Vᵢ and eigenvalues lambdaᵢ satisfy:
[M]Vᵢ=λᵢVᵢ

Note that any eigenvector V can be multiplied by a constant and will still be an eigenvector. Therefore, appropriate eigenvector normalization is necessary to get unique eigenvectors. This normalization is arbitrary. The lambda's are determined by solving:
det|M−λI|=0

where I is the identity matrix.

In order for the above approach to be utilized effectively to generate accurate skew models for a process, large volumes of measured data for that process are typically required. The present invention addresses the problem of coming up with skew models when little or no data is available for a new process.

The approach of the present invention is to utilize the parameter values from the typical models provided by the foundry without using any skew models from the foundry. For any given technology there are multiple different kinds of transistors that can be fabricated with different characteristics (i.e., oxide thickness, channel length, doping, etc.). These different kinds of transistors may be high speed transistors, low voltage transistors, input/output transistors, transistors optimized for RF, etc. Because each different type of transistor has different model parameters due to different physical characteristics, there is enough information contained in the typical models to perform a principal components analysis. In an alternative embodiment, it would be possible to include typical models from more than one foundry in order to get a larger set of data.

To appreciate why principal components, which describe correlations between model parameters are physically correct, consider the following. As explained above with respect to FIG. 1, we know that as the gate oxide decreases, the overlap capacitance should increase. Thus, for the BSIM3 model in particular, if T_{OX} goes down, CGSO and CGDO should go up. Similarly, as the gate oxide thickness decreases, the mobility should go down; so for BSIM3, if T_{OX} goes down, U0 should go down as well. These are physical properties of the BSIM3 model, or, more correctly, physical properties of a MOS device reflected in the BSIM3 model equation construction. If measured data indicates otherwise, then it is most likely the data is bad. For these reasons, developing skew models based on typical model parameters rather than on measured data may give better results if there is bad data, a poorly designed process or errors in data collection.

FIG. 2 illustrates an embodiment of a system for generating a foundry skew model. Data files 202, such as those representing typical model parameters, are stored in memory unit/device 201 and operated on by processor 205. The results of such processing can be viewed on display 203 and control over such processing can be made using input device 204. The result of the processing of the present invention can be stored in data files 202. The memory unit 201, processor 205, display device 203, and input device 205 are able to communicate with each other over a data communication line 206, which can comprise a serial bus connection, local area network, wide area network, wireless data link, etc.

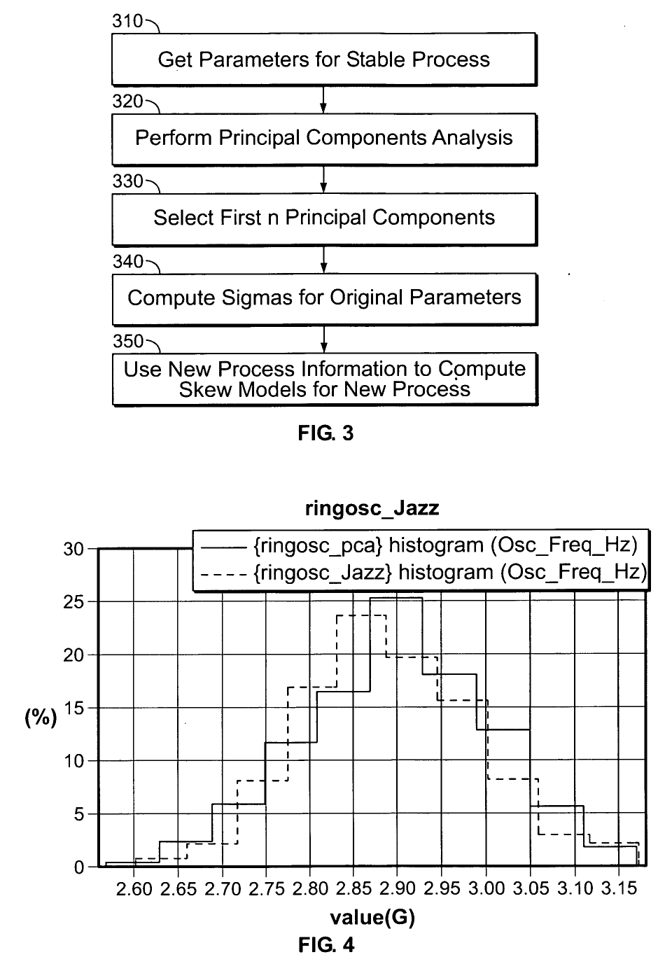

FIG. 3 illustrates steps of a method incorporating an embodiment of the present invention. In step 310, typical model parameters are obtained for a stable process. This may involve a single foundry or across multiple foundries. In step 320, principal components analysis, as described above is performed. This step yields an ordered set of linear equations of model parameters with associated variances. In step 330, the top n principal components are chosen, where n is a small integer that is selected based on the variances of the principal components. In step 340, the sigmas for the selected principal components are used to compute sigmas for each of the original parameters. Finally, in step 350, information from the new process is used to adjust the sigmas and to set the typical values for each of the model parameters for the new process. This step yields a complete skew model for the new process.

Note that the sigmas generated in step 350 are relative to a particular process spread that is unknown since the process started with typical parameters values and not a skew model for the old process. This means that the sigmas need to be multiplied by an overall factor that sets the overall process spread. It is possible to adjust this overall factor to match the foundry supplied process spread for the new process. In doing so, this guarantees that the width of the new Monte Carlo distribution will match that supplied by the foundry. Note that this does not, however, guarantee that the distribution shape or height will be the same. Adjusting the sigmas is tantamount to deciding how big a spread there should be between the best and worst case scenarios results.

### EXAMPLE

The present section provides an example to further illustrate an embodiment of the present invention. The following steps were performed:

1. Jazz Foundry PDK CA18HR parameter sets were obtained.

2. Principal components analysis was performed on these parameter sets.

3. The top three principal components were selected.

4. The relative sigma's for all the principal components were computed.

5. Sigmas for the original model parameters were computed from these sigmas.

Principal components analysis was performed on 17 of the BSIM3 parameters: lint, wint, u0, vth0, k1, k2, k3, k3b, dvt0, dvt2, tox, dlc, rdsw, cj, cjsw, cgs0, cgd0, while the remaining parameters were ignored. The result of the principal component analysis generated the following lambdas for the principal components:

| | |
|---|---|
| lambda[1] | 8.250E+00 |
| lambda[2] | 6.113E+00 |
| lambda[3] | 2.637E+00 |
| lambda[4] | 1.874E−07 |
| lambda[5] | 1.020E−07 |
| lambda[6] | 5.307E−08 |
| lambda[7] | 2.086E−08 |
| lambda[8] | 1.742E−08 |
| lambda[9] | 1.154E−08 |
| lambda[10] | 1.772E−09 |
| lambda[11] | 0.000E+00 |
| lambda[12] | 0.000E+00 |
| lambda[13] | 0.000E+00 |
| lambda[14] | 0.000E+00 |
| lambda[15] | 0.000E+00 |
| lambda[16] | 0.000E+00 |
| lambda[17] | 0.000E+00 |

It can be seen from the above data that only the first three principal components are statistically significant. The value of the fourth eigenvalue is seven orders of magnitude smaller than the third. Thus, it is safe to keep the first three principal components while discarding the others. For the first three principal components, principal components analysis performed for the example of this section yields the coefficients provided below. These coefficients represent three orthogonal linear combinations of the original BSIM2 variables:

| | PC(1) | PC(2) | PC(3) |
|---|---|---|---|
| lint | −2.9888E−01 | 2.3585E−02 | −1.5888E−01 |
| wint | 1.1638E−01 | 4.0319E−01 | −2.1661E−01 |
| u0 | −2.6140E−01 | 2.5624E−02 | −4.3756E−01 |
| vth0 | −1.0917E−01 | −5.3595E−01 | 6.4897E−03 |
| k1 | 2.7524E−01 | −1.3497E−01 | −4.1574E−01 |
| k2 | −7.7119E−02 | −1.2935E−01 | 3.9607E−01 |
| k3 | −3.1158E−01 | 4.9323E−01 | −5.5086E−02 |
| k3b | −9.8682E−03 | 1.1123E−01 | −1.9364E−01 |
| dvt0 | 6.4690E−01 | −2.7887E−02 | −2.2867E−01 |
| dvt2 | −2.2973E−01 | −1.4724E−01 | 3.8412E−02 |
| tox | −2.2973E−01 | −1.4724E−01 | 3.8412E−02 |
| dlc | −2.2973E−01 | −1.4724E−01 | 3.8412E−02 |
| rdsw | −2.2973E−01 | −1.4724E−01 | 3.8412E−02 |
| cj | −2.2973E−01 | −1.4724E−01 | 3.8412E−02 |
| cjsw | −2.2973E−01 | −1.4724E−01 | 3.8412E−02 |
| cjswg | −2.2973E−01 | −1.4724E−01 | 3.8412E−02 |
| cgso | −2.2973E−01 | −1.4724E−01 | 3.8412E−02 |

FIG. 4 illustrates skew distributions found by traditional methods and by an embodiment of the present invention—namely, a new method for generating foundry skew models. With respect to the exemplary skew distributions provided in FIG. 4, Jazz sample data are considered. The only “fitting” that was done for the new method was to choose an overall multiplier for the sigmas of the principal components such that the width of new distribution more or less matches that of the traditional method. While the new distribution width matches that of the traditional method, this does not necessarily guarantee that the shapes of the skew distributions will be the same. Nevertheless, the shapes of the two distributions in FIG. 4 are very similar, which validates the new method for generating foundry skew models in the present example. The shape and width of the new distribution has been matched to the shape and width of the traditional distribution by adjusting one parameter to fit the overall width.

Having thus described a preferred embodiment of the method and system for generating foundry skew models using principal components analysis, it should be apparent to those skilled in the art that certain advantages of the within system have been achieved. It should also be appreciated that various modifications, adaptations, and alternative embodiments thereof may be made within the scope and spirit of the present invention. For example, the generation of a skew model for a BSIM3 model has been illustrated, but it should be apparent that the inventive concepts described above would be equally applicable to a EKV model. The invention is further defined by the following claims.

What is claimed is:

1. A method for generating a new foundry skew model for a new semiconductor manufacturing process, comprising:
selecting an existing foundry skew model for an existing semiconductor manufacturing process;
selecting typical model parameters for the existing foundry skew model;
performing principal component analysis on the typical model parameters to generate linear equations that comprise principal components, each principal component accounting for different degrees of variance in the typical model parameters;
extracting a subset of the principal components that account for the majority of the variance in the typical model parameters, the extracted principal components each having associated principal component variances;
transforming the principal component variances into typical model variances for the typical model parameters; and
generating the new foundry skew model by utilizing the typical model variances.

2. The method of claim 1, wherein generating the new foundry skew model comprises using the calculated typical model variances to yield a Monte Carlo skew model.

3. The method of claim 1, wherein selecting an existing foundry skew model comprises selecting a BSIM3 model.

4. The method of claim 3, wherein selecting typical model parameters comprise typical values for lint, wint, u0, vth0, k1, k2, k3, k3b, dvt0, dvt2, tox, dlc, rdsw, cj, cjsw, cgs0, and cgd0.

5. The method of claim 1, wherein selecting an existing foundry skew model comprises selecting an EKV model.

6. The method of claim 1, wherein extracting the subset of the principal components comprises selecting ones of the principal components having lambda values that are at least two orders of magnitude greater than corresponding lambda values for the other principal components.

7. A computer program product contained on a storage media and having instructions executable by a processor, the instructions comprising:
selecting an existing foundry skew model for an existing semiconductor manufacturing process;
selecting typical model parameters for the existing foundry skew model;
performing principal component analysis on the typical model parameters to generate linear equations that comprise principal components, each principal component accounting for different degrees of variance in the typical model parameters;
extracting a subset of the principal components that account for the majority of the variance in the typical model parameters, the extracted principal components each having associated principal component variances;
transforming the principal component variances into typical model variances for the typical model parameters; and
generating the new foundry skew model by utilizing the typical model variances.

8. The computer program product as recited in claim 7, wherein the new foundry skew model comprises a Monte Carlo model.

9. The computer program product as recited in claim 7, wherein the selected existing foundry skew model comprises BSIM3 model.

10. The computer program product as recited in claim 9, wherein the selected typical model parameters comprise typical values for lint, wint, u0, vth0, k1, k2, k3, k3b, dvt0, dvt2, tox, dlc, rdsw, cj, cjsw, cgs0, and cgd0.

11. The computer program product as recited in claim 7, the new foundry skew model comprises an EKV model.

12. The computer program product as recited in claim 7, the extracted subset of principal components comprises ones of the principal components having lambda values that are at least two orders of magnitude greater than corresponding lambda values for the other principal components.

13. A system for generating a new foundry skew model for a new semiconductor manufacturing process, comprising:
a memory unit that stores data files, the data files comprising typical model parameters for an existing semiconductor manufacturing process; and
a processor that is in communication with the memory unit;
wherein the processor is programmed to:
retrieve the typical model parameters for the existing foundry skew model;
perform principal component analysis on the typical model parameters to generate linear equations that comprise principal components, each principal component accounting for different degrees of variance in the typical model parameters;
extract a subset of the principal components that account for the majority of the variance in the typical model parameters, the extracted principal components each having associated principal component variances;
transform the principal component variances into typical model variances for the typical model parameters; and
generate the new foundry skew model by utilizing the typical model variances.

14. The system as recited in claim 13, further comprising an input device for controlling the processor.

15. The system as recited in claim 13, further comprising a display device for viewing processing results of the processor.

16. The system as recited in claim 13, wherein the new foundry skew model comprises a Monte Carlo model.

17. The system as recited in claim 13, wherein the selected existing foundry skew model comprises BSIM3 model.

18. The system as recited in claim 17, wherein the selected typical model parameters comprise typical values for lint, wint, u0, vth0, k1, k2, k3, k3b, dvt0, dvt2, tox, dlc, rdsw, cj, cjsw, cgs0, and cgd0.

19. The system as recited in claim 13, the new foundry skew model comprises an EKV model.

20. The system as recited in claim 13, the extracted subset of principal components comprises ones of the principal components having lambda values that are at least two orders of magnitude greater than corresponding lambda values for the other principal components.
